(19) United States
(12) Patent Application Publication
(10) Pub. No.: US 2010/0290032 A1
(43) Pub. Date: Nov. 18, 2010

(54) METHOD AND SYSTEM FOR MEASURING AND DETERMINING/IDENTIFYING DIFFERENT MATERIALS

(75) Inventor: Renato Bugge, Trondheim (NO)

Correspondence Address: DENNISON, SCHULTZ & MACDONALD, 1727 KING STREET, SUITE 105, ALEXANDRIA, VA, 22314, US

(73) Assignee: INTEGRATED OPTOELECTRONICS AS, Trondheim (NO)

(21) Appl. No.: 12/744,111

(22) PCT Filed: Oct. 2, 2008
(86) PCT No.: PCT/NO2008/000348

§ 371 Date: Jul. 13, 2010

(30) Foreign Application Priority Data
Nov. 22, 2007 (NO) 20075984

(51) Int. Cl. G01N 21/35; G01N 21/47; G01N 21/55; G01N 21/59

(52) U.S. Cl. 356/51; 356/337; 356/445; 356/432

(57) ABSTRACT

Method and system for measuring/depicting and determining/identifying one or more objects of different types of plastics, different types of fabrics or clothing, different types of glass, different types of food/groceries, different types of cardboard/paper/wooden products and/or different types of metals or similar materials. The method includes considering the reflected, scattered and/or transmitted light from the laser through the material, and determining the type of material from this.

The invention relates to a method for measuring/depicting and the determination/identification of objects made of plastics, fabric, food, paper, glass and/or metal or similar by the use of a tunable laser, especially for use in connection with sorting. Objects made of different types of plastics, food/groceries, paper, glass and/or metal or similar can be identified by examining the spectral information provided by such materials, preferably within the 1-10 μm wave-length band. This is done by examining the light reflected, scattered and/or transmitted by the laser through the material, and based on this determining the type of material. It is important firstly that a laser is used so that the maximum light possible can be provided (especially at low reflection), and secondly that the correct wave-length band is chosen so as to identify as closely as possible the different materials.

A line scanner arrangement can be used to provide a spatial image of the materials, in which the laser is moved back and forth over the target, in one axis (x-axis). This can be combined with a two-dimensional image of the objects/materials, by transporting these past the scanner line (x-axis), along the other axis (y-axis), thereby creating an angle with the x-axis. This angle is preferably 90 degrees.

### BACKGROUND

The way materials are measured with light is by utilizing wave-lengths, which have the capability to absorb, transmit or reflect the given material. Today, this is usually done by a camera operated within an infrared or visible area, in combination with a light source and possibly an optical filter [1]. Such cameras can be very expensive as they use large, special sensors in InGaAs or similar materials [1]. They cannot sweep the optical spectrum to provide detailed spectral information on the object, but must use either a prism to scatter the light over several sensors or optical filters. This reduces the amount for the intensity/wave-length and limits the velocity and spectral resolution, which limits the spectral method which can be used (reflection). We here show a system which, combines the low costs of visual cameras, with an accuracy and velocity levels, which exceed those of thermal/infrared cameras in that they use a sweepable laser, preferably in the 1-10 μm infrared band. The radiation from the laser is used to measure the different materials by spectroscopic sweeping between different wave-lengths, thereby enabling these to be identified at their respective different absorption, reflection and/or transmission spectra.

In comparison with an infrared camera or other filter based spectroscopic systems [1], a sweepable laser can provide accurate spectral information consisting of up to tens, hundreds or thousands of measuring points within the spectrum. This is in contrast to a camera, which must use either an optical filter for each point, or possibly use another spectral dividing element, such as an optical prism or grille to scatter the light, and in this way measure the different components. For both camera based and array based spectroscopic methods, this will result in a reduction in velocity, as the amount of light will decrease in relation to the number of measuring points (they must be divided and only be provided with 1/n part light for n measuring points).

For a laser based spectroscopic system, the amount of light will always be the total amount of light emitted by the laser, plus any background light. A detector must thus be able to be utilized in its entire dynamic range, as the intensity is higher than that available from prism/grille based systems. This results in higher velocities, as the laser can be pulsed up to the MHz and sometimes the GHz regime to increase the dynamic range and frequency and filter the signal to increase the signal-to-noise ratio. By combining this with, either a single axis line scanning or an optical element to scatter the light over one line, a one-dimensional image of the object(s) to be analyzed and sorted, can be obtained.

### OBJECT

The object of the invention is to disclose a design and a method for providing a laser based system for analyzing and sorting different types of plastics, fabric, food, paper, different types of glass and/or different types of metal by the use of a tunable laser, preferably a sweepable infrared laser. It is also an object that the method should be reliable and that it can be used for different types of lasers.

The object of the invention is also to provide a more rapid and accurate solution than prior art solutions.

### THE INVENTION

A method according to the invention is described in claim 1. Preferable features of the method are described in claims 2-13.

A system for analysing and sorting material is described in claim 14. Preferable features of the system are described in claims 15-28.

The invention will be described below in detail with references to the attached drawings, where:

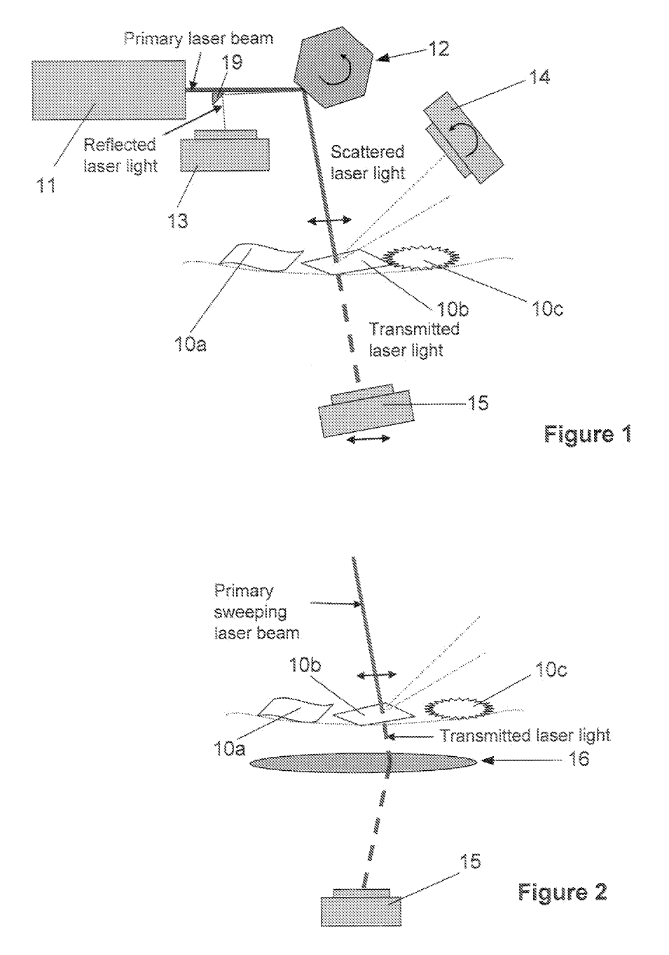

FIG. 1 is an example of a first embodiment according to the invention,

FIG. 2 is an example of an alternative embodiment of the transmission in FIG. 1,

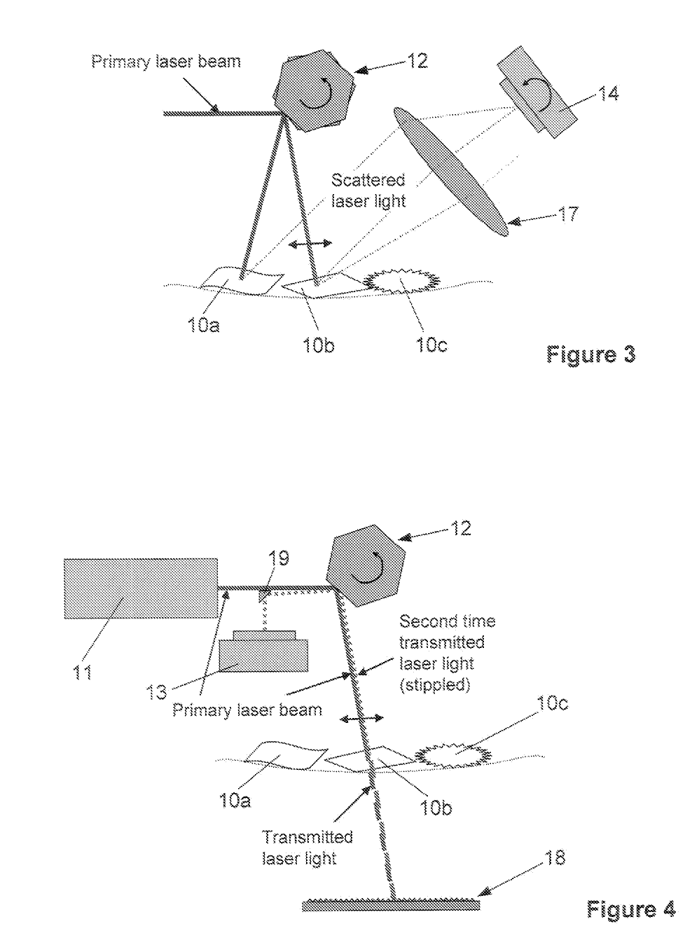

FIG. 3 is an example of an alternative embodiment for receiving the scattered laser light in FIG. 1,

FIG. 4 is an example of an alternative embodiment of FIG. 1,

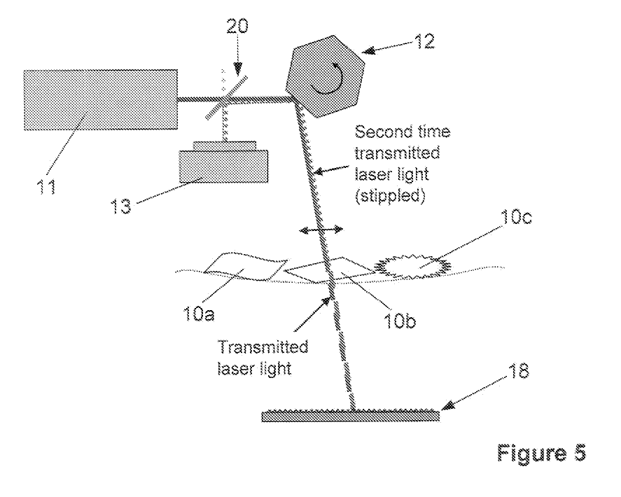

FIG. 5 is an example of an alternative embodiment of FIG. 1 or FIG. 4,

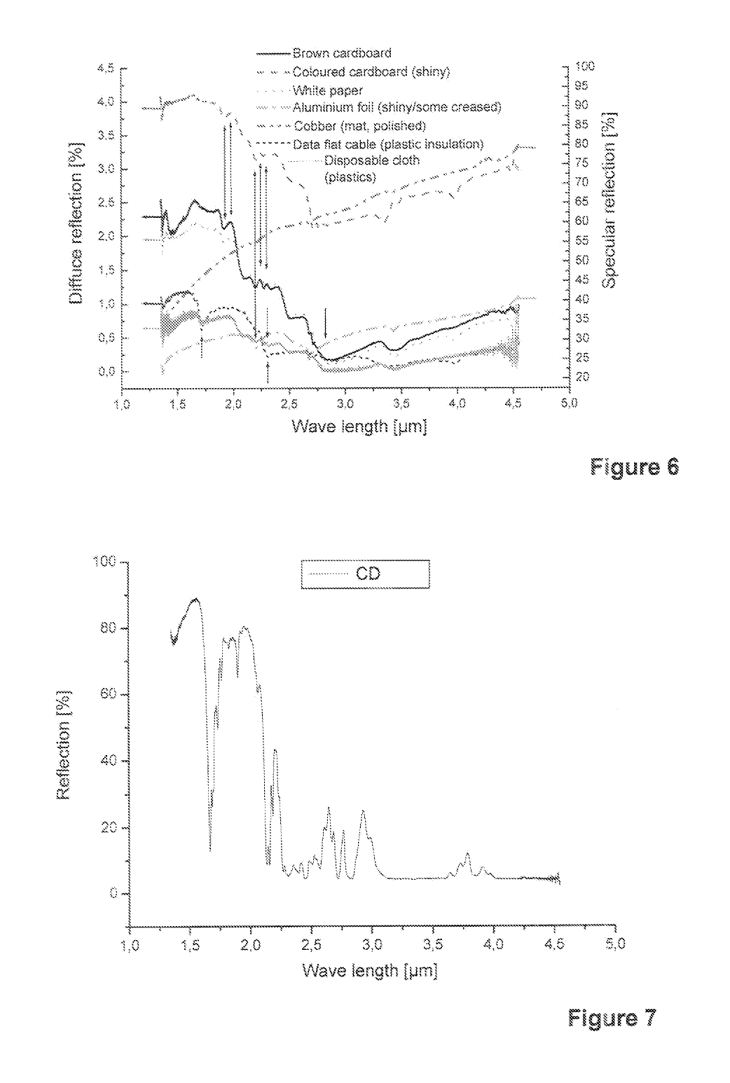

FIG. 6 shows reflection spectra for brown cardboard, coloured cardboard, white paper, aluminium foil, copper, data flat cable and disposable cloth,

FIG. 7 shows the specular reflection from a CD plate,

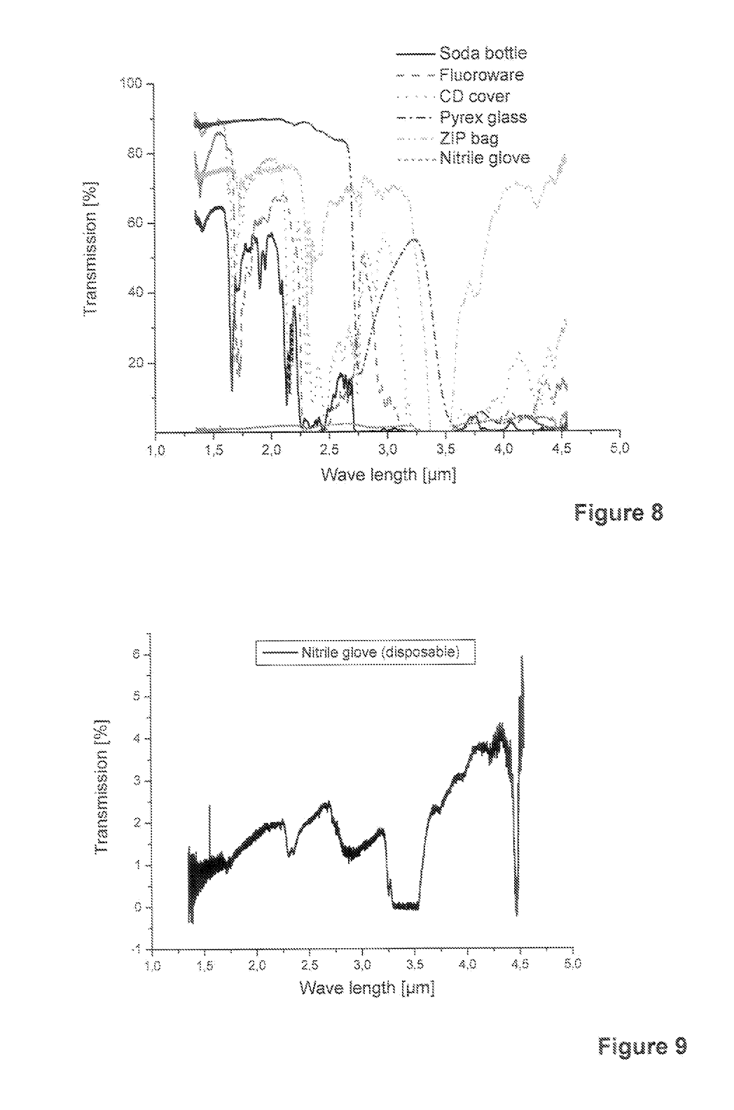

FIG. 8 shows the transmission through different transparent materials,

FIG. 9 shows the transmission through a disposable glove,

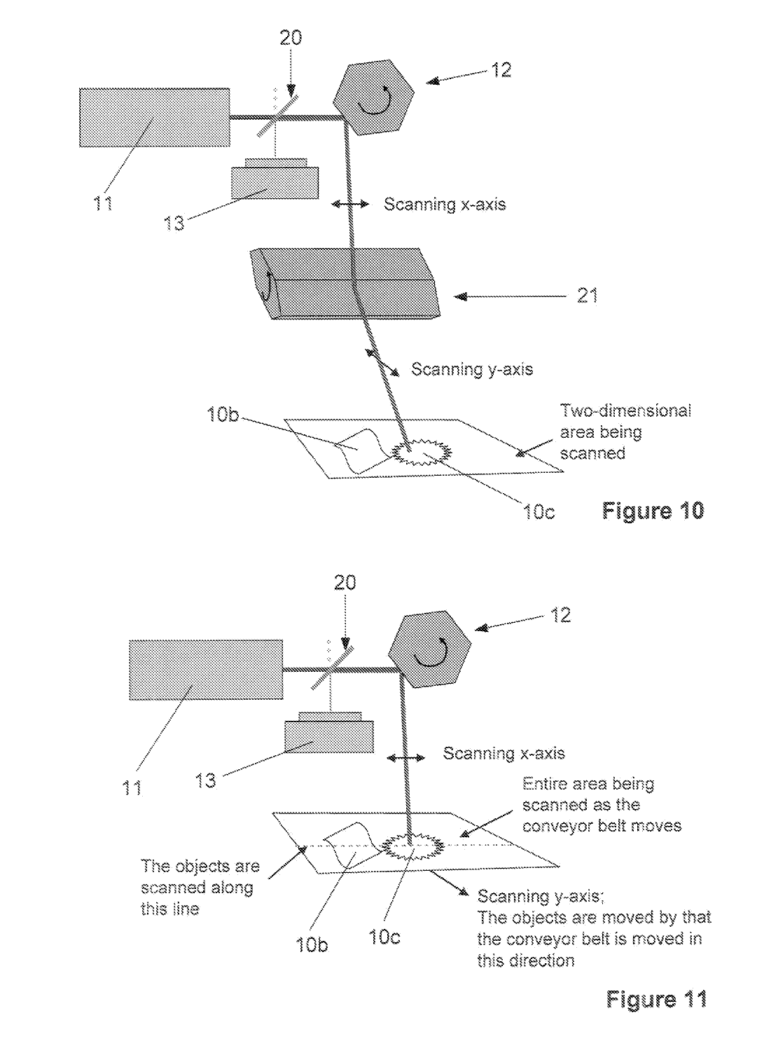

FIG. 10 shows the two-dimensional scanning of objects for sorting,

FIG. 11 is an alternative embodiment for the two-dimensional scanning of objects for sorting,

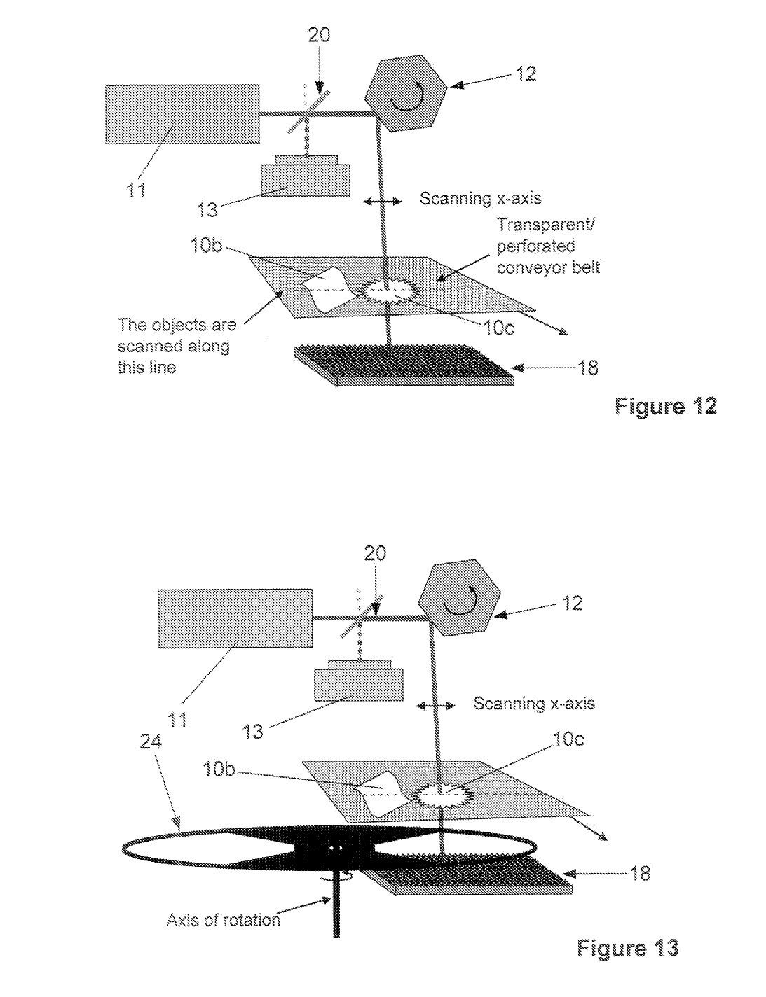

FIG. 12 is an alternative embodiment for the two-dimensional scanning of objects for sorting, as shown in FIG. 11,

FIG. 13 is an alternative embodiment for the two-dimensional scanning of objects for sorting, as shown in FIG. 12,

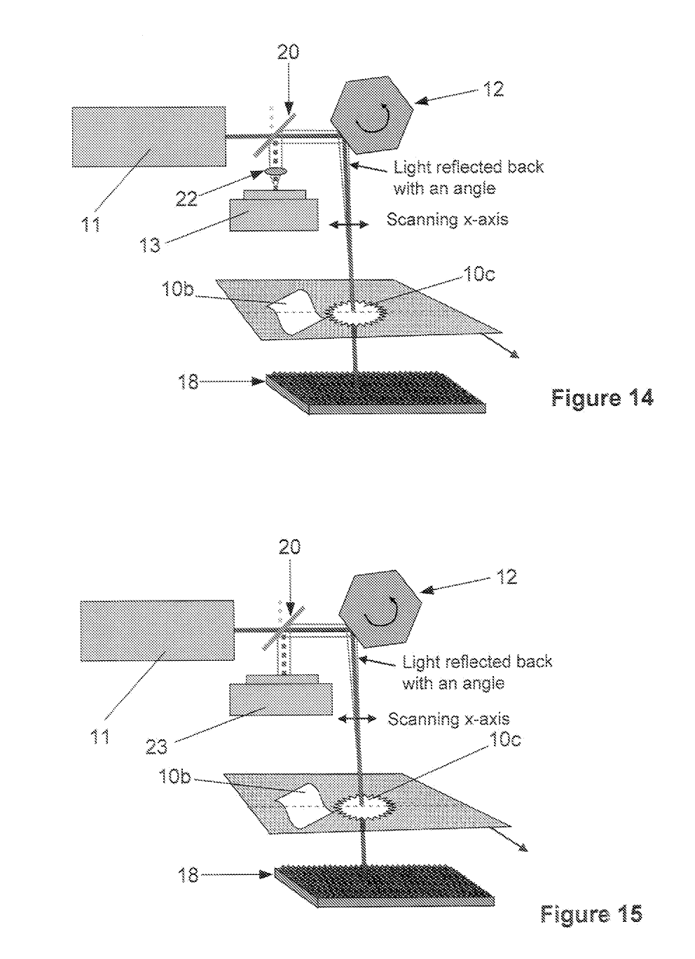

FIG. 14 is an alternative embodiment for two-dimensional scanning of objects for sorting, as shown in FIG. 12,

FIG. 15 is an alternative embodiment for two-dimensional scanning, as shown in FIG. 12,

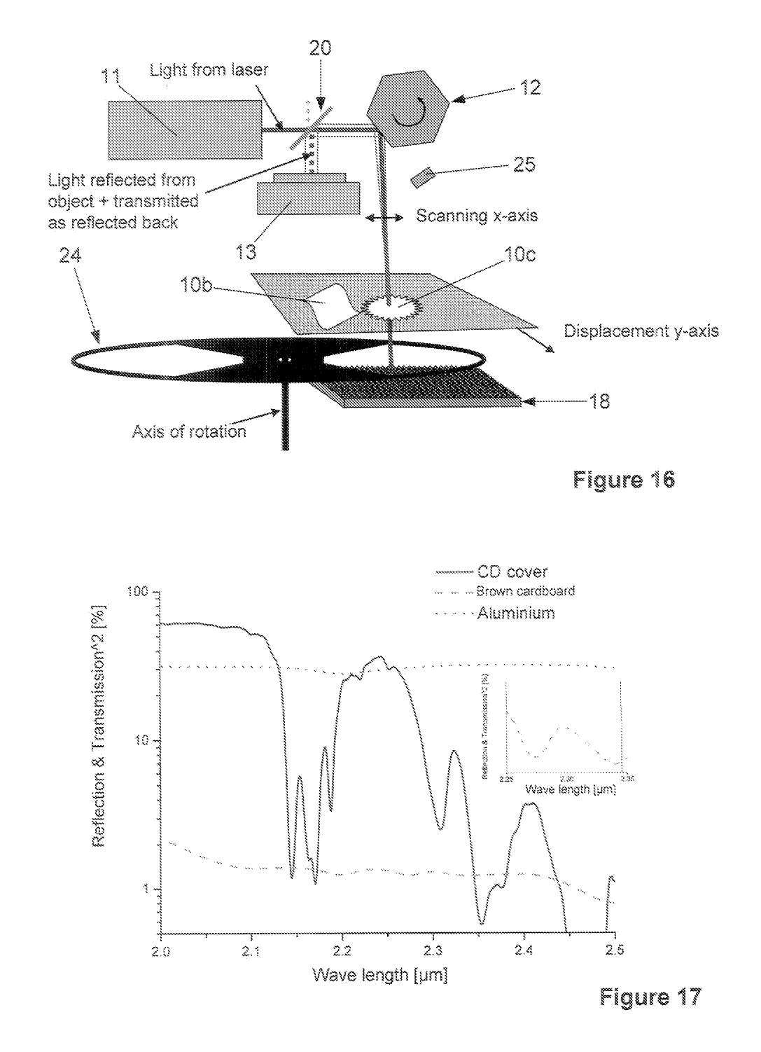

FIG. 16 is an alternative embodiment for two-dimensional scanning, as shown in FIG. 15,

FIG. 17 shows measurements of different materials in the system, as shown in FIG. 16,

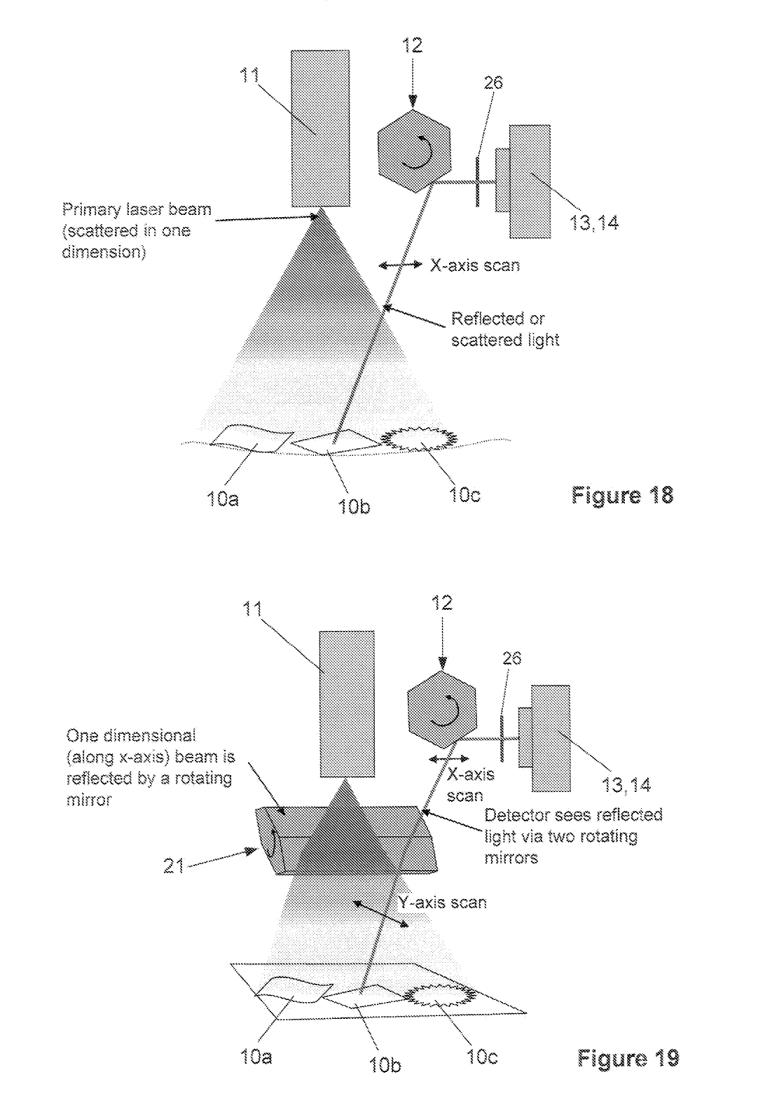

FIG. 18 is an example of scanning with a detector,

FIG. 19 shows scanning with a detector, as shown in FIG. 18, but with a y-axis scan, and

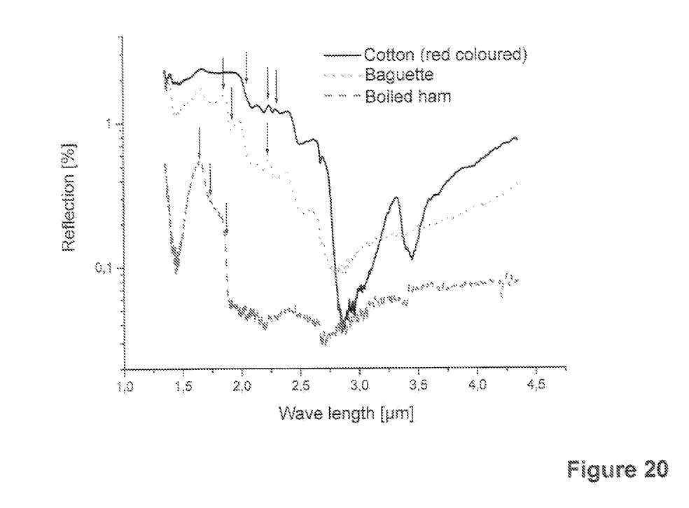

FIG. 20 shows different organic materials with low reflection levels.

To provide an optical system for identifying different materials, spectral information is acquired by tuning an infrared laser so that the optical response of the material can be registered. In this respect there are three methods which can be utilized, all based on illuminating the object with the tunable laser, but with different arrangements of the system and the data which is obtained.

1) A first method is based on an observation of the laser light reflected back, i.e. a specular reflection which provides a high signal as the object scatters a low amount of light and has a shiny surface, which sends a large amount of light back. Examples of such objects are shiny painted surfaces, polished metal, metal foil, metallised glass, etc. The materials which reflect infrared light the most are metals, while painted surfaces may have different reflection coefficients where single wave-lengths are reflected more. Glass will in the same way reflect much, while borosilicate glass has an absorption dependency for wave-lengths of >˜1.7 μm, rendering it identifiable (see FIG. 8).

Shiny plastic surfaces also reflect some light, but plastics also have organic compounds, which give them a very distinct reflection dependency in the infra red range. By tuning the laser over several wave-lengths it is possible to identify this “finger-print” which is distinct for each type of plastics. In this way it will be possible to sort many types of plastics, not only by colour, but also by type. A common feature of plastics is that not all the pieces are equally shiny, so that the intensity of the specular reflection can vary greatly.

Other materials, such as wood, cardboard and paper, give a minimal specular reflection, provided that their surfaces have not been painted. Plastics may also be painted, but they are mostly coated, but as it is cheaper to add the colour directly into the plastics, this is less common.

FIG. 6 shows light reflected by different materials.

2) A second method is based on scattered light, i.e. light from surfaces which are not shiny, but which scatter the light in all directions as a result of irregularities in their surfaces. There are objects and materials, which provide a low amount of reflected light (as used in method 1), and the two methods are thus complementary for observing objects with different levels of reflection. As in the first method, a metal may scatter a large amount of light if it is not shiny. This scattering is less wave-length-dependent than other materials, and it will be greater for a matt metallic surface. Matt glass and plastics also produce a lot of scattering, but in the same way as discussed above, the wave-length dependency is more distinct, especially as regards plastics, which have organic bonds. In contrast to method 1, wood, cardboard and paper will provide much light for method 2, so that the latter may also be used to distinguish different types of wood, cardboard and paper. By combining method 1 and 2, a good analytical basis for metal, glass, plastics, wood and paper/cardboard can be obtained, so that hundreds of types can be sorted for recycling, and the risk of different types of materials becoming intermingled can be minimized.

FIG. 6 shows light reflected by different materials.

3) A third method is based on the light transmitted by the objects. This is important for those materials that are highly transparent in the infrared range. It is so that there are very few materials that do not reflect light within one or more infrared ranges, but when this is the case, it will be possible to distinguish those that are covered with other materials from those that are not. Soda bottles, for example, are partly transparent in some infrared ranges, so that it is easy to see if they have labels or if they are still partly full. As soda bottles will also reflect/scatter some light, method 3 can be combined with method 1 and/or method 2 for an accurate determination of the type of material, content and label.

FIG. 8 shows light transmitted through different materials.

All these methods provide information about the material hit by the laser beam. The use of conveyor belt carrying different objects or objects of different sizes in now commonplace in industry, the laser can be swept over one axis, as described in the FIGS. 1 to 4. A common feature of these solutions is the use of a tunable laser, a rotating mirror and one or more optical detectors to measure the light from the laser. As the mirror in FIGS. 1 to 4 rotates, the laser beam will hit different parts of the object (see FIG. 3, which shows two different mirror positions). By pulsating the laser light, which is being utilized, it is possible to spatially divide the object into data points as the beam moves. The smallest point which can be divided will be the width of the laser beam, and in this way all the points can be assembled into a one-dimensional image of the object as the beam moves across it. The system is thus a one-dimensional scanner.

To get a more complete image of the object(s), either a movable number two mirror can be used to sweep the other axis, or a rolling belt where the objects are moved past the one dimensional scanner. By scanning repeatedly over the object, it is thus possible to assemble a two-dimensional image of several single-dimensional scans, as the object moves a given distance between each scan. FIG. 10 shows such a design.

A three-dimensional scan can also be obtained by utilizing several detectors, i.e. an array which measures the position of the reflection point of the laser (height of the object, z-axis). By replacing the detector in FIG. 4 with a stationary array, and providing this configuration in FIG. 11, it will be possible to measure the x-axis (scanning), the z-axis (detector array) and also the y-axis (movement in conveyor belt).

Further details of the invention will appear from the following example description.

### EXAMPLE

The invention will now be described in detail by means of examples.

To provide a system for the identification and determination of different materials, a combination of specular reflection, diffuse reflection and transmission is combined with a laser based light source 11, as described in FIGS. 1-5 and FIGS. 10-15.

The objects 10a-c are illuminated by the infrared laser light which is reflected by the rotating mirror 12, and scans along one axis (x-axis, from left to right in the Figure, with rotation as shown in the Figures, inverted with reversed rotation). FIGS. 1-5 show different configurations for this.

FIG. 1 is an example of one embodiment, where a rotating mirror 12 sweeps the laser beam in one axis over the objects 10a-c to be measured, and the light which is reflected travels back via the rotating mirror 12 and hits a detector 13. Alternately, instead of or in combination the scattered laser light can be measured by means of a detector 14 and/or the transmitted laser light can be measured by means of a detector 15.

FIG. 2 is an example of an alternative embodiment of the transmission in FIG. 1, with a system for collecting the transmitted light by means of a collector lens 16, which eliminates the need for moving the detector 15, which collects the transmitted light. The collector lens 16 can be an ordinary refractive lens, a diffractive lens or another object which functions in the same way (for example a spherical mirror or similar).

FIG. 3 shows an example of an alternative embodiment for the collection of the scattered light in FIG. 1. A lens 17 collects some of the scattered light from the objects 10a-c as the light is being swept over them. There is thus no need to move the detector 14 for it to see light from different objects 10a-c. The collector lens 17 can be an ordinary refractive lens, an index lens, a diffractive lens or another object, which functions in the same way (for example a spherical mirror or similar).

FIG. 4 is an example of an alternative embodiment of FIG. 1, where a retro-reflector/reflex 18 sends the transmitted light back with a small angular displacement so that the light can be measured with a detector 13, at the side of the laser. In this arrangement, reflected light can also contribute to the light in the detector, but only if the re-transmitted light is reflected through 180 degrees. This arrangement will require the detector 13 to be arranged with a mirror 19 close to the laser 11.

FIG. 5 is an example of an alternative embodiment of FIG. 1 or 4, where reflected light from the objects 10a-c or transmitted light is reflected back (from a retro-reflector/reflex 18) have the same path back via the original laser beam. A beam splitter 20 ensures that approximately 50% of the recurring light goes into a detector 13 to be measured. Referring now to FIG. 10, this shows two-dimensional scanning of objects 10a-c for sorting.

The objects 10a-c here lie stationary and a rotating mirror 21 provides a scanning of the y-axis. The detector 13 will here see specular reflection, but can be combined with the solutions in FIGS. 1-5 to measure several parameters. The Figure shows, as mentioned, how scanning can be performed in two dimensions to cover a two-dimensional area. This is done, while the x-axis is scanned, by moving the laser 11a short distance in the y-axis for each scan. This is done by means of a rotating number two mirror 21, which reflects the light so that it can move freely along the y-axis for all positions along the x-axis. Alternatively, instead of moving the laser light along the y-axis with a mirror 21, the objects 10a-c can be moved with a conveyor belt, such as a table or similar, as shown in FIGS. 11-15. In this way is achieved a relative movement in the y-axis is obtained between light and objects 10a-c.

The light hitting the objects 10a-c from a two-dimensional scan can be registered by arranging a detector 13 in/at the light axis from the laser 11, as shown in FIG. 1, 4 or 5.

Referring now to FIG. 11, this also shows a two-dimensional scanning of objects 10a-c for sorting. Instead of a rotating mirror 21 to sweep in the y-axis direction (as in FIG. 10), the objects 10a-c are arranged on a conveyor belt which moves past the scanner. In this way an image of the passing objects 10a-c can be provided.

Referring now to FIG. 12, this also shows a two-dimensional scanning of objects 10a-c for sorting, as shown in FIG. 11, but with a reflector 18 under the conveyor belt, which is also partly transparent/perforated. Alternatively, the conveyor belt can itself be reflective in some points to make transmission measurement possible for parts of the scan.

Referring now to FIG. 13, this shows a two-dimensional scanning, as shown in FIG. 12, but with a rotating chopper 24 to periodically absorb the light. While the chopper 24 is blocking transmitted light, it will not return to the detector 13, which thus only sees reflected light from the objects 10a-c. As the chopper 24 allows transmitted light to pass, this will be reflected in the retro-reflector/reflex 18, and thereafter return to the detector together with the light reflected by the objects 10a-c.

FIGS. 10-13 have the same arrangement as FIG. 5, but also here the arrangement shown in FIG. 1 or 4 can be used. The detector 13 in these arrangements is meant to collect light reflected back, i.e. objects 10a-c which provides specular or diffuse reflection, possibly a combination of these. This light will follow the same path, but in the opposite direction to the laser light. A drawback with this arrangement is that only a small part of the light will be collected by the detector 13 and this amount will be final. This can be improved by providing a lens 22 in front of the detector 13, such as shown in FIG. 14, possibly using the configuration of FIG. 3. Alternatively, an array 23 of several detectors can be used to measure the light with different directions, as shown in FIG. 15.

The transmitted light in FIGS. 1, 2 and 4 is measured in slightly different ways. The arrangement in FIG. 1 has the advantage that it only sees the transmitted light and that the detector 15 can be of such a size and have such a field of vision, which results in little background light but a significant amount of signal. The disadvantage is that the detector 15 must be moved very accurately and the mechanics thus become costly. An improvement of this can be seen in FIG. 2, which uses a collector lens 16 (refractive or diffractive lens) which means that the detector can be arranged at its focal point, and still collects all the light. The field of vision here will need to be larger to cover a wider area, and thus produces more background light, so that a large lens 16 is needed. FIG. 4 eliminates the need for a large lens 16 and replaces it with a retro-reflector/reflex 18. This will always reflect the light straight back and will thus provide most light by the use of a beam splitter 20, as shown in FIG. 5. The disadvantage of a retro-reflector/reflex 18 is that the light must pass the objects 10a-c twice, and the amount of light can thus be less than for the detector arrangements in FIGS. 4 and 5 in relation to FIG. 1 and/or 2. In the arrangements in FIGS. 10, 12 and 13, the retro-reflector/reflex 18 can be replaced by the methods shown in the arrangements of FIGS. 1 and 2 to measure transmission (for FIG. 10 given a transparent/perforated fabric/table on which the objects 10a-c lie.).

The directions of movement of the objects 10a-c are either out of or into the picture. As one or more objects 10a-c are scanned along the x-axis and the y-axis, the intensity from the reflection and/or transmission measurement will produce a two-dimensional image. The intensity in this image will be dependent on how much reflection and/or transmission the object 10a-c has at the wave-length being used. As the laser 11 can change wave-lengths by adjusting temperature or supplied current, it is possible to sweep a wave-length range where the materials of interest have identifiable reflection and/or transmission curves in the wave-length range.

FIG. 6 shows the reflection from different materials. Different materials produce a different reflection, but objects made of approximately the same material have reflection spectrum details, which makes them identifiable. As can be seen, there are some distinct peaks and/or troughs areas which can be used to identify a material, or group of materials. For example, brown cardboard and white bleached copy paper will, among others, provide peaks at 1.98 μm and 2.30 μm. This is a chemical “finger-print” which is related to the organic composition of paper. Coloured cardboard (card board with shiny colour print) produces in the same way peaks at 1.98 μm and 2.30 μm, so that even if the reflection is somewhat higher, a relative change around these peaks is identifiable. One method is thus to look at the first derivative of the signal which provides a “finger-print” for the material, so that it can be identified. In comparison, a disposable cloth in plastic (polyethylene) provides distinct peaks around 2.30 μm. Sometimes, these can resemble the peaks produced by paper, but the disposable cloth has no peak around 1.98 μm.

In the same way, it can be seen that other materials can be identified by their reflection properties, including plastic insulation from wire (data flat cable), and metals. The high reflection properties of metal make it possible for them to be distinguished in this manner. It is however more difficult to distinguish between metals, as they do not have chemical absorption of the light (the troughs around 2.2 μm and 2.7 μm are due to the spectrometer and not the metal).

Referring now to FIG. 7, which shows the specular reflection from a CD. As the light must pass the plastic before it is reflected, the spectrum is marked by the transmission properties of the plastic in the CD (polycarbonate). Many distinct peaks for polycarbonate can thus be seen, with especially good details from around 1.6 μm to 2.8 μm, and around 3.75 μm. In that regard, CDs and pieces of such are easily identified by the use of the arrangement with specular reflection. Diffuse reflection (scattering) from such objects on the other hand is low, and not really suitable for identification in this case.

Referring now to FIG. 8, this shows transmission through different transparent materials. The Figure shows how distinctive the signature is of the different plastic materials, especially from 1.6 μm to approximately 2.7 μm. Some types of plastic also have signatures for longer wave-lengths, but soda bottles, for example, have areas with high damping (˜2.7 μm to 2.9 μm and 3.2 μm to 3.6 μm) which not are suitable for identification of such. It is important to notice that Pyrex glass (borosilicate glass here) has a high variation in transmission at approximately 2.75 μm, which therefore is suitable for the identification of this type of material.

Referring now to FIG. 9, this shows transmission through a nitrile glove (as in FIG. 8). The disposable glove is made of a thin film of nitrile which lets some light pass through. As for other organic materials, it has distinct troughs/peaks, especially around 2.35 μm, which are easily identifiable.

A plain system for the sorting of materials is based on a tunable laser 11 in the mid infrared wave-length band. The system is assembled as shown in FIG. 16, with sweeping of the light along the x-axis, objects 10a-c moving along the y-axis on a transparent fabric, and possibly a rotating chopper 24. The chopper 24 can be omitted if the fabric only is transparent in some areas, i.e. where the transmission is blocked in some points, although it does pass at other points. The system preferably also includes a mirror 25 to mark the end of x-axis scan, which is used for synchronising.

The laser 11 and detector/detector array 23 are connected to an external communication means (not shown) with a system panel, a controller (not shown), a data logger (not shown) or a PC (not shown) for storing and further data analysis.

The result of this in practice is that:

1) The wave-length of the laser light is controlled by the external unit and tuned over a wave-length range, preferably 2.25 μm to 2.35 μm.
2) For each spatial point spectral data will be collected by obtaining the signal from the detectors 23, while the laser 11 is tuned, preferably by increasing the current passing through the laser.
3) After data is collected for a point, the system will continue the collection by moving the laser 11 in the x-axis (in that the rotating mirror 12 has rotated a given angle), and collection in point 1) starts again. At the same time the data collected in point 2) will be processed.
4) The data processing for a point will be done in one of the following ways:
a) The system tries to identify fixed finger-prints for different materials. This is performed by finding peaks and troughs in the data, preferably by looking at the first derivate of these. The peaks and troughs are then compared with records of peaks and troughs for different types of materials so that the material can be identified accordingly.
b) The system divides the collected data in a number of points N. The amount of data, N, will then be transferred to a neural network program, which has been processed to determine the type of material against a data library of different materials. The bits with data resulting from the neural network will indicate the material by comparing this with a given combination of bits.
c) Using a combination of the techniques provided under a) and b).

If none of the methods result in an unambiguous answer, data will be combined from two or more points on an object to increase the signal-to-noise ratio. This is done by combining spectral data for several successive points on the x-axis, if the spectra are approximately the same, i.e. if the total of the quadrants of the difference for each spectral point is low (method of least squares). The data are combined by looking at an average spectrum, i.e. an average value for each spectral point.

In the same way, several points along the y-axis can be combined in that the system stores spectra for several lines along the x-axis. As an example, 3 points along x and 3 lines along y:

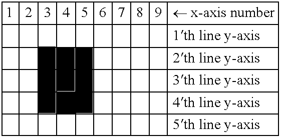

For 3 times 3 points; The value of the black point (y-axis=4, y-axis=3) are provided by the value of the 9 points around (gray).

This reduces the dissolution of the system, but as long as all the points that contribute to the value are of the same object, this will increase the accuracy of the identification of the material in the object.

For example, a brown cardboard, a CD cover and a metal can of aluminium can be distinguished by scanning the three objects. FIG. 17 shows how the data from the mid detector in the detection array 23 becomes when it is measured with the arrangement in FIG. 16. For the CD cover it is only the transmission, which contributes to the data, so that the detector in the middle will not show a very low signal from this object. In the same way, the signal will be zero as the chopper blocks the transmitted light, and it is thus possible to determine that the object is transparent. Brown cardboard and aluminium only provide reflection, something which is easily measured as the chopper 24 blocks the transmitted light (then, the CD cover provides no signal). The small image shows the details of the reflection from cardboard in the area 2.25 μm to 2.35 μm, between 1.2% and 1.4%.

These three objects will not cause problems in determining what is what. Reflection levels, transmittance and details in the spectrum from 2.25 μm to 2.35 μm make it easy for them to be distinguished. However, as numbers of materials and data increase, it becomes more difficult distinguishing between transparent and non-transparent materials could be carried out in two libraries in order to limit the size of the libraries. In the same way, non-transparent materials with high reflection levels can also be separated from materials with low reflection levels in order to reduce the size of the library further.

Referring now to FIG. 18, this shows an example of scanning with a detector, where the laser 11 includes the optical scattering of light in a thin line (scattered along x-axis, but not y-axis). The detector 13, 14 receives reflected/scattered light from one point. The observed point can be displaced along this line. The Figure contains a rotating mirror 12 used to displace the point being observed. An aperture 26 limits the light reaching the detector 13, 14. To provide a two-dimensional scan, the objects 10a-c are moved in the y-axis direction.

Referring now to FIG. 19, this shows scanning with a detector 13, 14, as shown in FIG. 18, but with a y-axis scan, where the laser 11 includes optical scattering of light in a thin line (scattered along the x-axis) which is then scanned along the y-axis with a rotating mirror 21. The detector 13, 14 receives reflected/scattered laser light from one point. The observed point is displaced over an area via the two rotating mirrors 12, 21, so that it always sees the laser light hitting the sample. Also an aperture 26 is preferably arranged here, which limits the light reaching the detector 13, 14.

As mentioned, the FIGS. 18 and 19 show an alternative embodiment where one laser line is used having a greater width in one dimension, and a smaller width in the other dimension. These arrangements must thus use a rotating mirror 12 to sweep the observed area, as the detector 13, 14 will only be provided with light from the point at which the object 10a-c is to be measured. Alternatively, the transmitted light can be considered in the embodiment as provided in FIGS. 18 and 19, but the detector 15 then has to be arranged below the objects 10a-c, as shown in FIG. 1 or 2. A retro-reflector/reflex 18 will in the same way as for FIG. 4 or 5, require that the detector 13 is provided with a mirror 19 or beam splitter 20, close to the laser 11 in FIG. 18 or 19 (with the necessary optics).

FIG. 20 shows that materials/objects having low reflection levels can be recognised by studying the details in their respective reflection spectra. Different organic materials with low reflection levels, such as cotton, a baguette and boiled ham, all provides reflection spectra having details which are identifiable. Boiled ham has a wide variation in reflection from approximately 1.83 μm to 1.89 μm, a small peak at 1.74 μm, and a large peak at 1.65 μm. Cotton and baguette vary in their reflection around 2.0 μm, and in their fine structure in the range 2.2 μm to 2.5 μm and are thus easily identifiable. Baguette also has some peaks around 1.8 μm. Other groceries have similar identifiable spectra as they consist of materials with organic bonds. This includes fruit, vegetables, pastry, chocolate, confectionary candy, meat and fish. The invention will thus cover all types of food/groceries.

### Modifications

Alternative embodiments of the invention may be:
i) The use of an optic insulator after the laser to dampen the light which possibly must pass back to the laser after the beam splitter,
ii) The use of several detectors to measure distance/depth to the object by triangulation,
iii) The use of spectral filter(s) to limit background light contributing to noise in the signal,
iv) Enclosing the arrangement in a dark chamber to reduce background light contributing to noise,
v) Using a spectral filter to examine light being emitted from the object, where this is not laser light (photo-luminescent or similar),
vi) Connecting the system to a conveyor belt for continuously measuring different materials/objects,
vii) Using the system for sorting different materials,
viii) Using the system to date groceries,
ix) Using the system to identify contaminated or deteriorated groceries,
x) Using the system to sort groceries with the purpose of improve the quality of the product(s),
xi) Using the system for sorting waste

### REFERENCES

[1] P. Tatzer, M. Wolf, T. Panner: “Industrial application for inline material sorting using hyperspectral imaging in the NIR range”, page 99-107, Real-Time Imaging, Vol. 11 (2005)

1. A method for measuring/depicting and determining/identifying one or more objects made of different types of plastics, different types of fabrics or clothing, different types of glass, different types of food/groceries, different types of cardboard/paper/wooden products and/or different types of metals or similar materials, characterized in that the method includes the following steps:
a) tuning of the wavelength of a laser by means of electric and/or thermal controlling,
b) illuminating the object to be determined,
c) measuring the reflected, scattered and/or transmitted light signal from the object in one or more detectors,
d) collecting and storing measurements in a microcontroller with an internal memory,
e) analyzing the measurements by means of a microcontroller,
f) calculating the type of material by means of one or more reference libraries or logarithms provided in the microcontroller.

2. Method according to claim 1, characterized in that a light signal from the laser is split and/or swept to illuminate a larger part of an object.

3. Method according to claim 2, characterized in that the light is swept in one axis/one dimension for the purpose of assembling a one-dimensional image.

4. Method according to claim 2, characterized in that the light is swept in one axis or two axes for the purpose of assembling a two-dimensional image.

5. Method according to claim 2, characterized in that the objects are moved past the split and/or swept light for the purpose of assembling a two-dimensional image

6. Method according to claim 4, characterized in that a detector also reads information about the third axis for the purpose of assembling a three-dimensional image.

7. Method according to claim 1, characterized in that the laser light is within the 1-10 μm wave-length band.

8. Method according to claim 1, characterized in that the laser light is within the 1.7-4.5 μm wave-length band.

9. Method according to claim 1, characterized in that the laser light is within the 2.0-3.7 μm wave-length band.

10. Method according to claim 2, characterized in that a mirror is moved to split and/or sweep the laser light along one or more axes.

11. Method according to claim 1, characterized in that a collector lens is used to collect the light signal for a detector.

12. Method according to claim 1, characterized in that a retro-reflector/reflex is used to reflect transmitted light back with a small angular displacement for measurement in a detector.

13. Method according to claim 1, characterized in that a mirror and/or a beam splitter is used to ensure that light back is directed against a detector.

14. System for measuring and determining/identifying one or more objects of different types of plastics, different types of fabrics or clothing, different types of glass, different types of food/groceries, different types of cardboard/paper/wooden products and/or different types of metals or similar materials, characterized in that the system includes a laser based light source (11), one or more movable, preferably rotatable mirrors (12, 21), and one or more optical detectors (13, 14, 15, 23) for measuring a reflected, scattered and/or transmitted light, respectively, signal from one or more objects (10a-c), which system is capable of scanning an object (10a-c) in one, two and/or three dimensions.

15. System according to claim 14, characterized in that the laser based light source (11) is a tunable laser, preferably a sweepable infrared laser.

16. System according to claim 14, characterized in that the system includes a mirror (19) and/or a beam splitter (20) to ensure that the returning light is directed in a detector (13) to be measured.

17. System according to claim 14, characterized in that the system includes one or more collector lenses (16, 17) (refractive or diffractive lens) to collect the transmitted light and/or scattered light, which prevents having to move the detectors (15, 14) which collect the transmitted light and/or scattered light.

18. System according to claim 14, characterized in that the system includes a retro-reflector/reflex (18) which sends transmitted light back with a small angular displacement so that the light can be measured by one or more detectors (13, 23).

19. System according to claim 14, characterized in that the movable mirror (12) is arranged to sweep the laser beam in one axis (x-axis) over the object(s) (10a-c), and reflect the reflected light back to a detector (13, 14).

20. System according to claim 14, characterized in that the movable mirror (21) is arranged to reflect the laser light along the y-axis for all positions along the x-axis.

21. System according to claim 14, characterized in that the system includes a rotating chopper (24) or similar, which is arranged to periodically absorb the light from the laser (11).

22. System according to claim 14, characterized in that the system includes means for moving the objects (10a-c) in one direction, such as a conveyor belt or similar.

23. System according to claim 22, characterized in that the conveyor belt is transparent and/or perforated.

24. System according to claim 14, characterized in that the laser (11) is provided with optical means for scattering the laser beam in one dimension.

25. System according to claim 14, characterized in that the system is provided with an aperture (26) to limit the light reaching the detector (13, 14).

26. System according to claim 14, characterized in that the system is provided with a mirror to mark the end of the x-axis scan for synchronizing.

27. System according to claim 14, characterized in that the system further includes external communication with a system panel, a microcontroller with internal memory and a data logger or PC for storing or further analyzing data.

28. System according to claim 27, characterized in that the microcontroller is provided with software, logarithms and one or more reference libraries for analyzing the measurements and for the subsequent recognition/determination of the object (10a-c).
